(19) United States
(12) Patent Application Publication
(10) Pub. No.: US 2010/0302182 A1
(43) Pub. Date: Dec. 2, 2010

(54) TOUCH PANEL WITH REDUCED CHARGE TIME

(76) Inventors: Fu-Cheng Wei, Hsin-Chu (TW); Yu-Min Hsu, Hsin-Chu (TW); Yung-Tse Cheng, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/616,778

(22) Filed: Nov. 11, 2009

(30) Foreign Application Priority Data
Jun. 2, 2009 (TW) 098118167

(51) Int. Cl. G06F 3/041

(52) U.S. Cl. 345/173

(57) ABSTRACT

A touch panel includes a sensing region, a storage unit, a precision rectifier circuit and a comparing circuit. There exists an equivalent capacitance at a predetermined location in the sensing region. At the predetermined location, the sensing region can provide a first signal before a touch action occurs and a second signal after the touch action occurs. The precision rectifier circuit can control the signal transmission path between the predetermined location and the storage unit. After being charged by the first and second signals, the storage unit can respectively provide corresponding third and fourth signals. The comparing circuit can thus determine whether the touch action occurs at the predetermined location according to the third and fourth signals.

### BACKGROUND OF THE INVENTION

1. Field of the Invention

The present invention is related to a touch panel, and more particularly, to a touch panel with reduced charge time.

2. Description of the Prior Art

Liquid crystal display (LCD) devices with thin appearance have gradually replay traditional bulky cathode ray tube (CRT) displays and been widely used in various electronic products. With rapid shrinkage in size, there is less room for traditional input devices such as keyboards or mice. Therefore, touch panels providing tactile inputs and display function have become more and more popular. There are various types of touch panels, such as resistive, capacitive, surface acoustic or infrared. Among those, capacitive touch panels detect capacitance variations corresponding to changes in static electricity caused by tactile inputs from a human finger or a stylus, thereby determining the actual location of the touch action.

Referring to FIG. 1, which is a diagram illustrating a prior art touch panel 100. The touch panel 100 includes a touch detection circuit 10 and a sensing region 15. A predetermined location in the sensing region 15, whose equivalent capacitance is represented by Ceq, receives a pulse signal Sp at a first end N1, and outputs a sensing signal Sa corresponding to its stored charges at a second end N2. The touch detection circuit 10 can detect voltage variations established at the predetermined location due to its equivalent capacitance Ceq, thereby determining whether a touch action occurs at the predetermined location.

The prior art touch detection circuit 10 includes a digital controller 110, a transmitter 122, a receiver 124, a signal detection circuit 130, a voltage amplifier 140, an analog-to-digital converter (ADC) circuit 150, a memory unit 160, and a comparing circuit 170. The digital controller 110 can generate the pulse signal Sp, as well as control signals S1-S3 for operating the signal detection circuit 130. The transmitter 122 and the receiver 124 can transmit the pulse signal Sp to the predetermined location having equivalent capacitance Ceq, and then transmit a sensing signal Sa to the signal detection circuit 130. The signal detection circuit 130 can detect the voltage level of the node N3 and provide a corresponding sensing signal Sb at the node N4. The voltage amplifier 140 can enhance the voltage level of the sensing signal Sb, thereby generating a corresponding sensing signal Sc. The ADC circuit 150 can convert the analog sensing signal Sc into a digital sensing signal Sd, which is then stored in the memory unit 160. According to the digital sensing signal Sd, the comparing circuit 170 determines whether a touch action occurs at the predetermined location having equivalent capacitance Ceq in the sensing region 15.

Referring to FIG. 2, which is a diagram illustrating the prior art signal detection circuit 130. The prior art signal detection circuit 130 includes a capacitor Cst and switches SW1-SW3. The switches SW1-SW3 operate based on the control signals S1-S3 transmitted from the digital controller 110. The switch SW1 provides a charging path so that the capacitor Cst can detect the voltage level of the node N3 and provide the corresponding sensing signal Sb at the node N4. The switches SW2 and SW3 provide discharging paths so that the capacitor Cst can repeatedly detect the voltage level of the node N3 after being cleared of its stored charges.

Referring to FIG. 3, which is a timing diagram illustrating the operation of the prior art touch panel 100. FIG. 3 depicts the waveforms of the pulse signal Sp, the sensing signal Sa (at the node N3), the sensing signal Sb (at the node N4), and the control signals S1-S3. The charge period of the touch panel 100 is represented by T, which includes a plurality of positive periods Tp and negative periods Tn. In the positive periods Tp for charging the capacitor Cst, the control signal S1 is at high voltage level, and the control signals S2 and S3 are at low voltage level . Therefore, with the switch SW1 being turned on and the switches SW2 and SW3 being turned off, the capacitor Cst is charged by the sensing signal Sa. In the negative periods Tn for charging the capacitor Cst, the control signal S3 is at high voltage level, and the control signals S1 and S2 are at low voltage level. Therefore, with the switch SW3 being turned on and the switches SW1 and SW2 being turned off, the node N3 can be discharged. After completing the charge period T, the controls signal S2 switches from low voltage level to high voltage level, and the control signals S1 and S3 are at low voltage level. Therefore, with the switch SW2 being turned on and the switches SW1 and SW3 being turned off, the node N4 can be discharged for clearing the charges stored in the capacitor Cst . In the charge period T, the sensing signal Sa fluctuates between low and high voltage levels. When the voltage level of the node N4 is higher than that of the node N3, a leakage path is created and a longer scan time is required for the capacitor Cst to store sufficient charges.

### SUMMARY OF THE INVENTION

The present invention provides a touch panel comprising a sensing region having an equivalent capacitance at a predetermined location and including a first end for receiving a pulse signal; a second end for providing a first signal before the touch panel receives a touch signal, and for providing a second signal after the touch panel receives the touch signal; and a touch detection circuit comprising: a storage unit for providing a third signal by storing energy corresponding to the first signal, or for providing a fourth signal by storing energy corresponding to the second signal; and a precision rectifier circuit having an input end coupled to the predetermined location and an output end coupled to the storage unit for controlling a signal transmission path between the predetermined location and the storage unit according to voltage levels of the input and output ends in a charge period of the storage unit.

The present invention further provides a touch panel comprising a sensing region having an equivalent capacitance at a predetermined location and including a first end for receiving a pulse signal; a second end for providing a first signal before the touch panel receives a touch signal and for providing a second signal after the touch panel receives the touch signal; and a touch detection circuit comprising a storage unit for providing a third signal by storing energy corresponding to the first signal, or for providing a fourth signal by storing energy corresponding to the second signal; and a precision rectifier circuit comprising an input end coupled to the predetermined location; an output end coupled to the storage unit; and an operational amplifier including: an output end coupled to the output end of the precision rectifier circuit; a first input end coupled to the input end of the precision rectifier circuit; and a second input end coupled to the output end of the operational amplifier.

The present invention further provides a method for determining where a touch signal occurs, comprising providing a storage unit; providing a pulse signal for charging a sensing region at a predetermined location having an equivalent capacitance; providing a precision rectifier circuit for controlling a signal transmission path between the predetermined location and the storage unit, wherein the precision rectifier circuit includes an input end coupled to the predetermined location and an output end coupled to the storage unit; turning on the precision rectifier circuit for charging the storage unit when the precision rectifier circuit has a higher voltage level at the input end than at the output end during a charge period of the storage unit; and turning off the precision rectifier circuit when the precision rectifier circuit does not have a higher voltage level at the input end than at the output end during the charge period of the storage unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art touch panel.

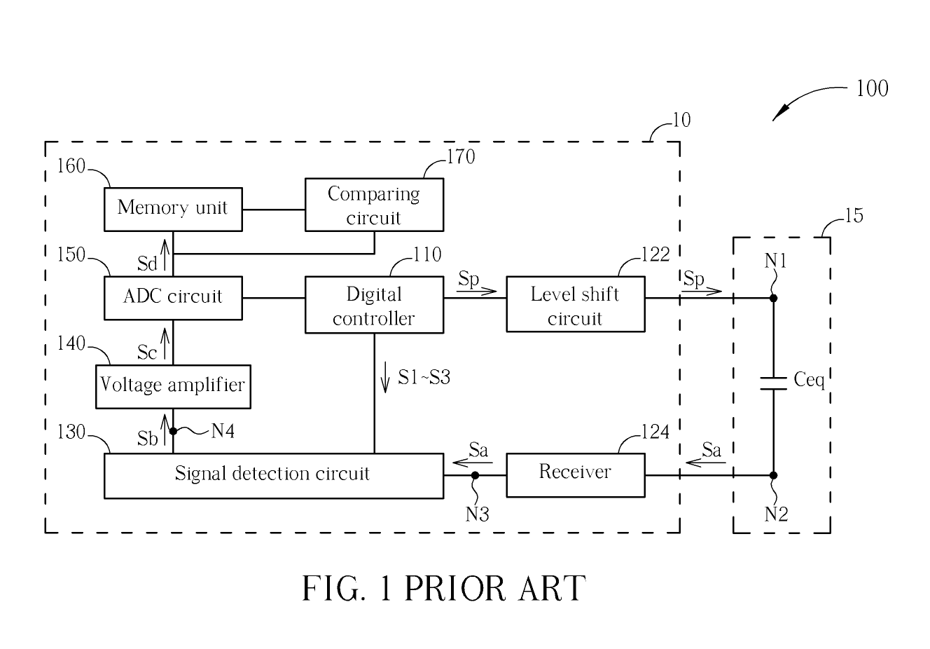

FIG. 2 is a diagram illustrating a prior art signal detection circuit.

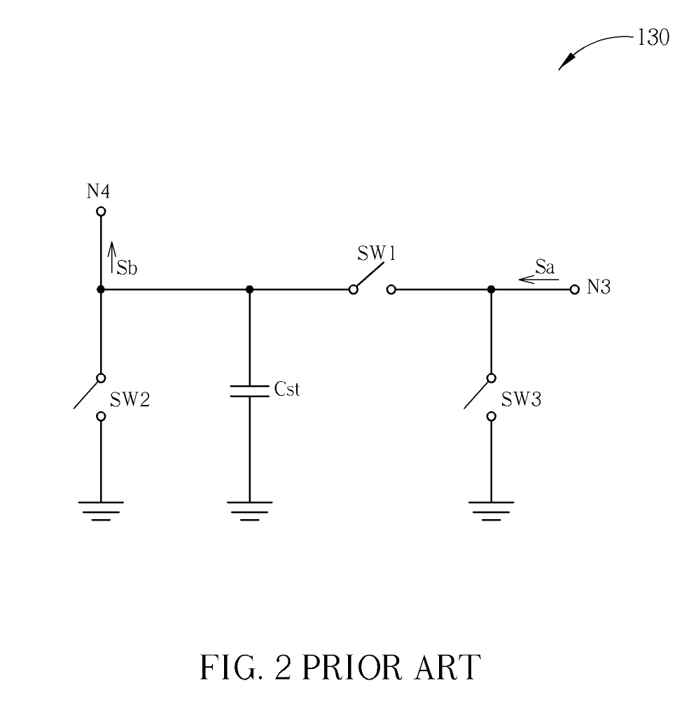

FIG. 3 is a timing diagram illustrating the operation of the prior art touch panel.

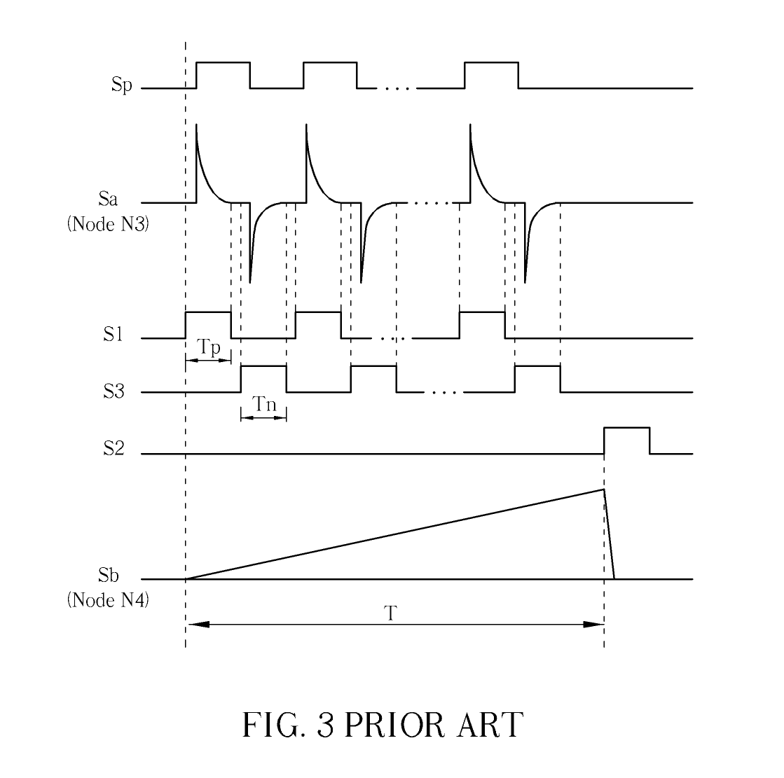

FIG. 4 is a diagram illustrating a touch panel according to the present invention.

FIG. 5 is a diagram illustrating a signal detection circuit according to a first embodiment of the present invention.

FIG. 6 is a diagram illustrating a signal detection circuit according to a second embodiment of the present invention.

FIG. 7 is a timing diagram illustrating the operation of the touch panel according to the first and second embodiments of the present invention.

FIG. 8 is a diagram illustrating a signal detection circuit according to a third embodiment of the present invention.

FIG. 9 is a diagram illustrating a signal detection circuit according to a fourth embodiment of the present invention.

FIG. 10 is a timing diagram illustrating the operation of the touch panel according to the third and fourth embodiments of the present invention.

### DETAILED DESCRIPTION

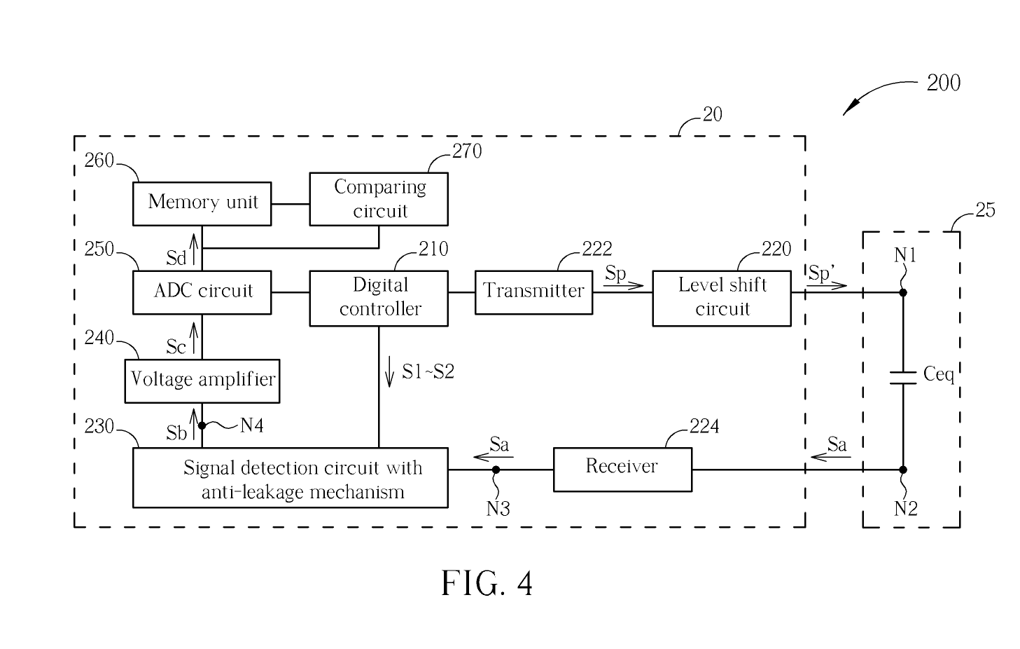

Referring to FIG. 4, which is a diagram illustrating a touch panel 200 according to the present invention. The touch panel 200 includes a touch detection circuit 20 with anti-leakage mechanism and a sensing region 25. At a plurality of predetermined locations in the sensing region 25, there exists equivalent capacitance. By detecting voltage variations established at each predetermined location due to respective equivalent capacitance, it can thus be determined whether and where a touch action occurs. FIG. 4 only depicts a specific predetermined location in the sensing region 25, whose equivalent capacitance is represented by Ceq. The sensing region 25 receives a pulse signal Sp at a first end N1, and outputs a sensing signal Sa corresponding to its stored charges at a second end N2. The touch detection circuit 20 with anti-leakage mechanism can detect voltage variations established at the specific predetermined location due to its equivalent capacitance Ceq, thereby determining whether a touch action occurs at the specific predetermined location.

The touch detection circuit 20 with anti-leakage mechanism includes a digital controller 210, a transmitter 222, a receiver 224, a signal detection circuit 230, a voltage amplifier 240, an ADC circuit 250, a memory unit 260, a comparing circuit 270, and a level shift circuit 220. The digital controller 210 can generate the pulse signal Sp, as well as control signals S1 and S2 for operating the signal detection circuit 230. The level shift circuit 220 can enhance the voltage level of the pulse signal Sp, thereby generates a pulse signal Sp′ with higher charging efficiency. The transmitter 222 and the receiver 224 can adopt multiplexers capable of transmitting the pulse signal Sp to the level shift circuit 220 and then transmitting a sensing signal Sa provided at the predetermined location having the equivalent capacitance Ceq to the signal detection circuit 230. The signal detection circuit 230 can detect the voltage level of the node N3 and provide a corresponding sensing signal Sb at the node N4. The voltage amplifier 240 can enhance the voltage level of the sensing signal Sb, thereby generating a corresponding sensing signal Sc. The ADC circuit 250 can convert the analog sensing signal Sc into a digital sensing signal Sd, which is then stored in the memory unit 260. According to the sensing signal Sd, the comparing circuit 270 determines whether a touch action occurs at the predetermined location having equivalent capacitance Ceq in the sensing region 25. For example, the sensing region 25 normally undergoes an initial scan during the start-up procedure, and the acquired digital sensing signal indicating “no touch action” is stored in the memory unit 260 as a reference value. If the digital sensing signal Sd received by the comparing circuit 270 during subsequent scans is equal to the reference value, it reveals no variation in the voltage level of at the predetermined location having equivalent capacitance Ceq, and it can thus be determined by the touch detection circuit 20 that no touch action has occurred in the sensing region 25 at the predetermined location having equivalent capacitance Ceq. If the digital sensing signal Sd received by the comparing circuit 270 during subsequent scans is different from the reference value, it reveals variations in the voltage level at the predetermined location having equivalent capacitance Ceq due to a touch action, and it can thus be determined by the touch detection circuit 20 where the touch action occurs.

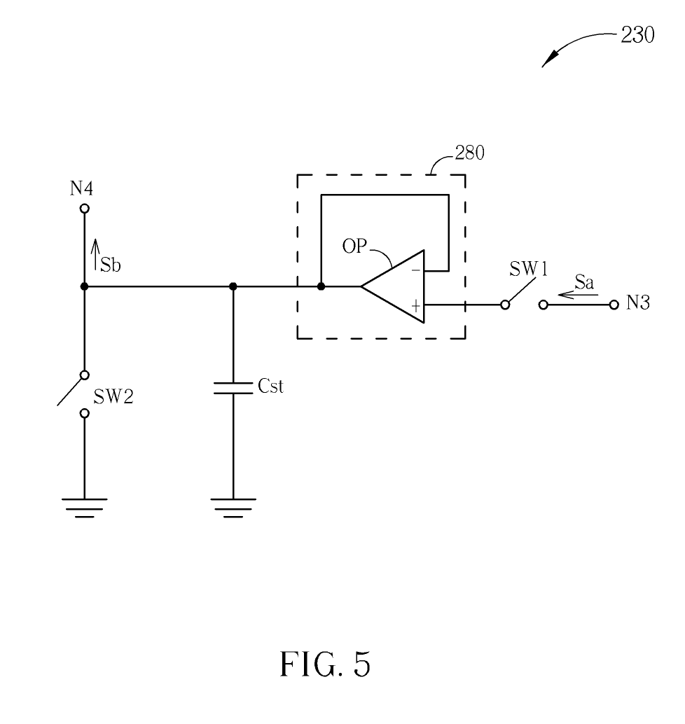

Referring to FIG. 5, which is a diagram illustrating the signal detection circuit 230 according to a first embodiment of the present invention. The signal detection circuit 230 includes a precision rectifier circuit 280, a capacitor Cst, and switches SW1 and SW2. The switches SW1 and SW2 operate based on the control signals S1 and S2 transmitted from the digital controller 210, respectively. The precision rectifier circuit 280 and the switch SW1 provide a charging path so that the capacitor Cst can detect the voltage level of the node N3 and provide the corresponding sensing signal Sb at the node N4. The switch SW2 provides a discharging path so that the capacitor Cst can repeatedly detect the voltage level of the node N3 after being cleared of its stored charges.

In the signal detection circuit 230 according to the first embodiment of the present invention, the precision rectifier circuit 280 includes an operational amplifier OP having an output end coupled to the node N4, a positive input end coupled to the node N3 via the switch SW1, and a negative input end coupled to the output end. The operational amplifier OP in the precision rectifier circuit 280 functions as a voltage follower with high input impedance and low output impedance. In other words, the forward-bias voltage Vf of the operational amplifier OP is nearly zero. As a result, the operational amplifier OP can provide a close-loop voltage gain very close to 1, and is equivalent to short-circuit when forward-biased. On the other hand, the operational amplifier OP can also provide a reverse-bias voltage Vb, and is thus equivalent to open-circuit when reverse-biased.

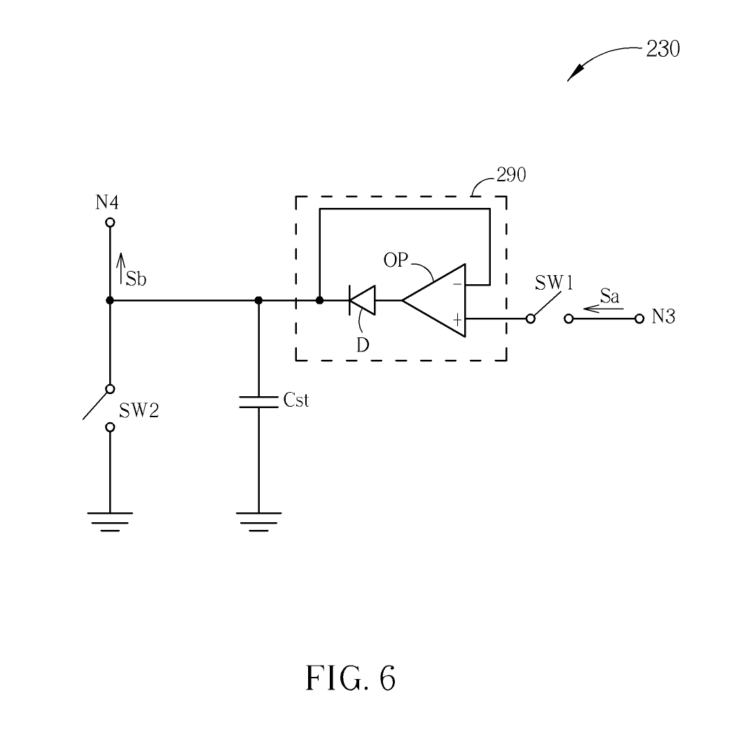

Referring to FIG. 6, which is a diagram illustrating the signal detection circuit 230 according to a second embodiment of the present invention. Having similar structure as the first embodiment, the second embodiment of the present invention also include the capacitor Cst and the switches SW1 and SW2, but differs in that the signal detection circuit 230 includes a precision rectifier 290. The precision rectifier circuit 290 includes an operational amplifier OP and a diode D. The positive input end of the operational amplifier OP is coupled to the node N3 via the switch SW1, the negative input end of the operational amplifier OP is coupled to the node N4, and the diode D is coupled between the negative input end and the output end of the operational amplifier OP. As previously explained, since the forward-bias voltage of the operational amplifier OP is nearly zero, the overall forward-bias voltage Vf of the precision rectifier circuit 290 is determined by the forward-bias voltage of the diode D. As a result, the precision rectifier circuit 290 is equivalent to short-circuit when forward-biased. On the other hand, the overall reverse-bias voltage Vb of the precision rectifier circuit 290 is determined by the reverse-bias voltages of the operational amplifier OP and the diode D. As a result, the precision rectifier circuit 290 is equivalent to open-circuit when reverse-biased.

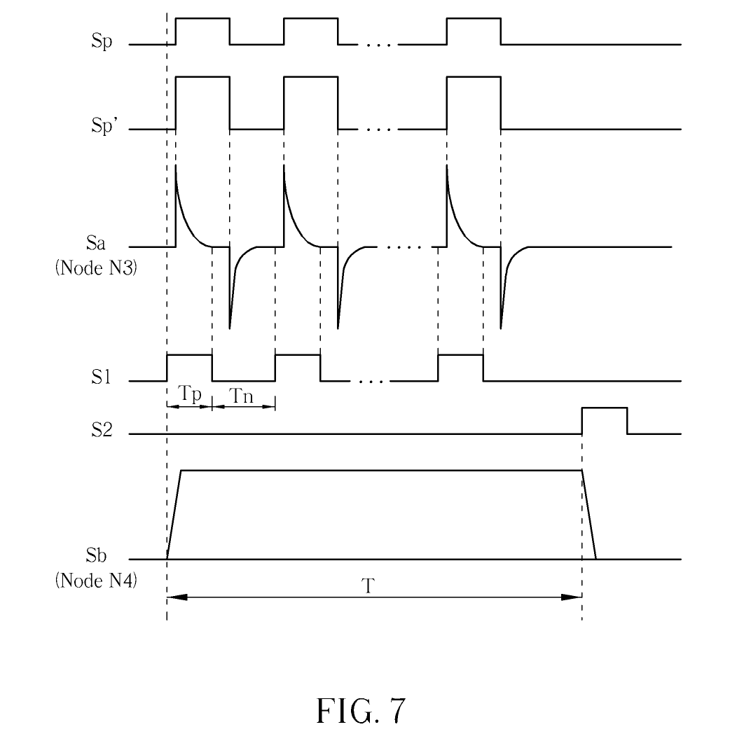

Referring to FIG. 7, which is a timing diagram illustrating the operation of the touch panel 200 according to the first and second embodiments of the present invention. FIG. 7 depicts the waveforms of the pulse signal Sp, the pulse signal Sp′, the sensing signal Sa (at the node N3), the sensing signal Sb (at the node N4), and the control signals S1-S2. The charge period of the touch panel 200 is represented by T, which includes a plurality of positive periods Tp and negative periods Tn. In the positive periods Tp for charging the capacitor Cst, the control signal S1 is at high voltage level, and the control signal S2 is at low voltage level, thereby turning on the switch SW1 and turning off the switch SW2. When the voltage level of the node N3 is higher than that of the node N4 and the voltage difference exceeds the forward-bias voltage Vf, the precision rectifiers 280 and 290 are equivalent to short-circuit, thereby charging the capacitor Cst with the sensing signal Sa. When the voltage level of the node N3 is lower than that of the node N4 and the voltage difference exceeds the reverse-bias voltage Vb, the precision rectifiers 280 and 290 are equivalent to open-circuit, thereby blocking the signal transmission path between the nodes N3 and N4 in order to avoid leakage in the capacitor Cst. In the negative periods Tn for charging the capacitor Cst, the control signals S1 and S2 are at low voltage level, thereby turning off the switches SW1 and SW2. After completing the charge period T, the control signal S1 is at low voltage level and the control signal S2 is at high voltage level, thereby turning on the switch SW2 and turning off the switch SW1. The node N4 can thus be discharged for clearing the charges stored in the capacitor Cst. Since the precision rectifiers 280 and 290 can control the signal transmission path between the nodes N3 and N4 and avoid leakage in the capacitor Cst, a shorter scan time is required for the capacitor Cst to store sufficient charges.

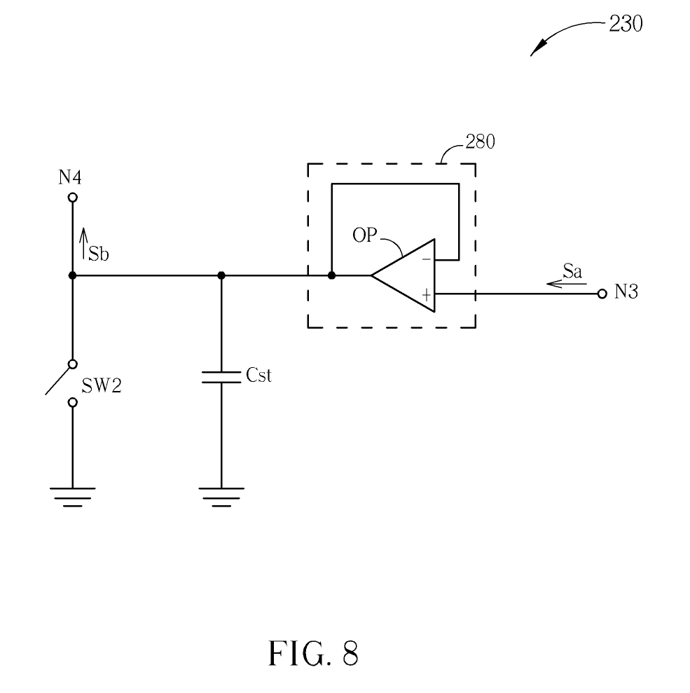

Referring to FIG. 8, which is a diagram illustrating the signal detection circuit 230 according to a third embodiment of the present invention. Having similar structure as the first embodiment, the third embodiment of the present invention also includes the capacitor Cst, the switch SW2 and the precision rectifier 280, but differs in that the positive input end of the operational amplifier OP is directly coupled to the node N3. The switch SW2 operates based on the control signal S2 transmitted from the digital controller 210. The precision rectifier circuit 280 provides a charging path so that the capacitor Cst can detect the voltage level of the node N3 and provide the corresponding sensing signal Sb at the node N4 . The switch SW2 provides a discharging path so that the capacitor Cst can repeatedly detect the voltage level of the node N3 after being cleared of its stored charges.

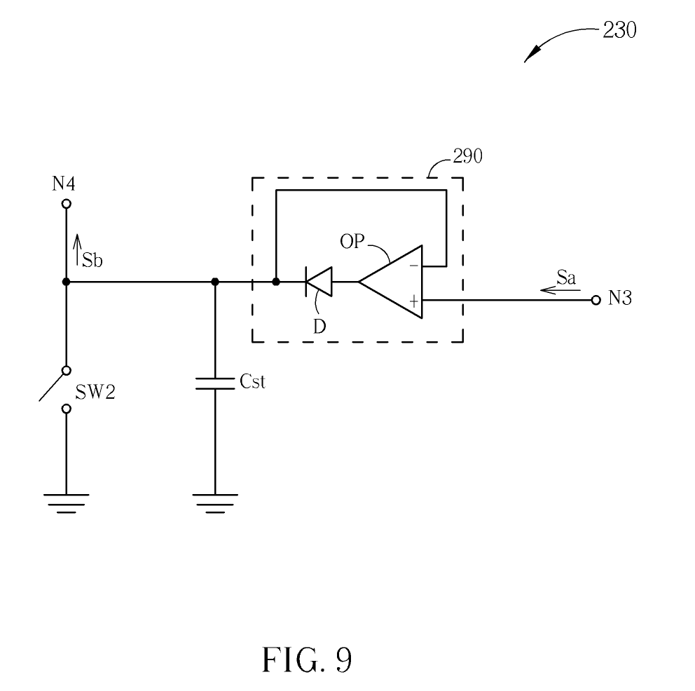

Referring to FIG. 9, which is a diagram illustrating the signal detection circuit 230 according to a fourth embodiment of the present invention. Having similar structure as the second embodiment, the fourth embodiment of the present invention also includes the capacitor Cst, the switch SW2 and the precision rectifier 290, but differs in that the positive input end of the operational amplifier OP is directly coupled to the node N3. The switch SW2 operates based on the control signal S2 transmitted from the digital controller 210. The precision rectifier circuit 290 provides a charging path so that the capacitor Cst can detect the voltage level of the node N3 and provide the corresponding sensing signal Sb at the node N4 . The switch SW2 provides a discharging path so that the capacitor Cst can repeatedly detect the voltage level of the node N3 after being cleared of its stored charges.

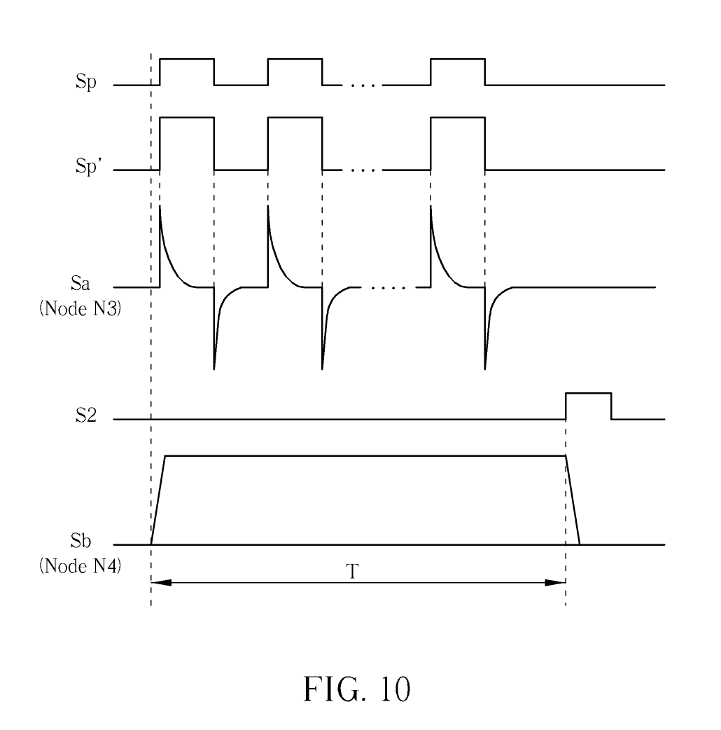

Referring to FIG. 10, which is a timing diagram illustrating the operation of the touch panel 200 according to the third and fourth embodiments of the present invention. FIG. 10 depicts the waveforms of the pulse signal Sp, the pulse signal Sp′, the sensing signal Sa, the sensing signal Sb, and the control signal S2. In the third and fourth embodiments of the present invention, the precision rectifiers 280 and 290 are controlled directly according to the voltage difference between the nodes N3 and N4. When the voltage level of the node N3 is higher than that of the node N4 and the voltage difference exceeds the forward-bias voltage Vf, the precision rectifiers 280 and 290 are equivalent to short-circuit, thereby charging the capacitor Cst with the sensing signal Sa. When the voltage level of the node N3 is lower than that of the node N4 and the voltage difference exceeds the reverse-bias voltage Vb, the precision rectifiers 280 and 290 are equivalent to open-circuit, thereby blocking the signal transmission path between the nodes N3 and N4 in order to avoid leakage in the capacitor Cst. After completing the charge period T, the control signal S2 is at high voltage level, thereby turning on the switch SW2. The node N4 can thus be discharged for clearing the charges stored in the capacitor Cst. Since the precision rectifiers 280 and 290 can control the signal transmission path between the nodes N3 and N4 and avoid leakage in the capacitor Cst, a shorter scan time is required for the capacitor Cst to store sufficient charges.

Those skilled in the art will readily observe that numerous modifications and alterations of the device and method may be made while retaining the teachings of the invention.

What is claimed is:

1. A touch panel, comprising:
a sensing region having an equivalent capacitance at a predetermined location and including:
a first end for receiving a pulse signal;
a second end for providing a first signal before the touch panel receives a touch signal, and for providing a second signal after the touch panel receives the touch signal; and
a touch detection circuit comprising:
a storage unit for providing a third signal by storing energy corresponding to the first signal, or for providing a fourth signal by storing energy corresponding to the second signal; and
a precision rectifier circuit having an input end coupled to the predetermined location and an output end coupled to the storage unit for controlling a signal transmission path between the predetermined location and the storage unit according to voltage levels of the input and output ends in a charge period of the storage unit.

2. The touch panel of claim 1, wherein in the charge period of the storage unit, the precision rectifier circuit conducts the signal transmission path between the predetermined location and the storage unit when the voltage level of the input end is higher than the voltage level of the output end, and blocks the signal transmission path between the predetermined location and the storage unit when the voltage level of the input end is not higher than the voltage level of the output end.

3. The touch panel of claim 1, wherein the precision rectifier circuit comprises:
an operational amplifier including:
an output end coupled to the output end of the precision rectifier circuit;
a first input end coupled to the input end of the precision rectifier circuit; and
a second input end coupled to the output end of the operational amplifier.

4. The touch panel of claim 3, wherein the precision rectifier circuit comprises:
a diode including:
an anode; and
a cathode coupled to the output end of the precision rectifier circuit; and
an operational amplifier including:
an output end coupled to the anode of the diode;
a first input end coupled to the input end of the precision rectifier circuit; and
a second input end coupled to the cathode of the diode.

5. The touch panel of claim 1, wherein the touch detection circuit further comprises:
a level shift circuit for enhancing a voltage level of the pulse signal.

6. The touch panel of claim 1, wherein the touch detection circuit further comprises:
a transmitter for transmitting the pulse signal to the sensing region; and
a receiver for receiving the first or the second signal.

7. The touch panel of claim 6, wherein the transmitter and the receiver include multiplexers.

8. The touch panel of claim 1, wherein the touch detection circuit further comprises:
a first switch coupled between the second end of the sensing region and the input end of the precision rectifier circuit for controlling a signal transmission path between the predetermined location and the precision rectifier circuit.

9. The touch panel of claim 1, wherein the touch detection circuit further comprises:
a second switch coupled in parallel with the storage unit for discharging the storage unit.

10. The touch panel of claim 1, wherein the touch detection circuit further comprises:
a digital controller for providing the pulse signal.

11. The touch panel of claim 1, wherein the touch detection circuit further comprises:
a voltage amplifier coupled to the storage unit for receiving and amplifying the third or the fourth signal;
an analog-to-digital converter (ADC) circuit coupled to the voltage amplifier for converting the third and fourth signals into a first digital signal and a second digital signal, respectively;
a memory unit for storing the first and second digital signals; and
a comparing circuit for determining whether the touch signal occurs on the predetermined location by comparing levels of the first and second digital signals.

12. The touch panel of claim 1, wherein the storage unit includes a capacitor.

13. A touch panel comprising:
a sensing region having an equivalent capacitance at a predetermined location and including:
a first end for receiving a pulse signal;
a second end for providing a first signal before the touch panel receives a touch signal and for providing a second signal after the touch panel receives the touch signal; and
a touch detection circuit comprising:
a storage unit for providing a third signal by storing energy corresponding to the first signal, or for providing a fourth signal by storing energy corresponding to the second signal; and
a precision rectifier circuit comprising:
an input end coupled to the predetermined location;
an output end coupled to the storage unit; and
an operational amplifier including:
an output end coupled to the output end of the precision rectifier circuit;
a first input end coupled to the input end of the precision rectifier circuit; and
a second input end coupled to the output end of the operational amplifier.

14. The touch panel of claim 13, wherein the precision rectifier circuit further comprises a diode having an anode coupled to the output end of the operational amplifier and a cathode coupled to the output end of the precision rectifier circuit.

15. The touch panel of claim 14, wherein the touch detection circuit further comprises:
a switch coupled between the second end of the sensing region and the input end of the precision rectifier circuit.

16. A method for determining where a touch signal occurs, comprising:
providing a storage unit;
providing a pulse signal for charging a sensing region at a predetermined location having an equivalent capacitance;
providing a precision rectifier circuit for controlling a signal transmission path between the predetermined location and the storage unit, wherein the precision rectifier circuit includes an input end coupled to the predetermined location and an output end coupled to the storage unit;
turning on the precision rectifier circuit for charging the storage unit when the precision rectifier circuit has a higher voltage level at the input end than at the output end during a charge period of the storage unit; and
turning off the precision rectifier circuit when the precision rectifier circuit does not have a higher voltage level at the input end than at the output end during the charge period of the storage unit.

17. The method of claim 16, further comprising:
enhancing a voltage level of the pulse signal for reducing a charge period of the predetermined location.

18. The method of claim 16, further comprising:
the sensing region providing a first signal at the predetermined location before receiving a touch signal;
the sensing region providing a second signal at the predetermined location after receiving the touch signal;
charging the storage unit with the first signal for providing a corresponding third signal; and
charging the storage unit with the second signal for providing a corresponding fourth signal.

19. The method of claim 18, further comprising:
comparing levels of the third and fourth signals for determining whether the touch signal occurs on a location associated with the equivalent capacitor.

20. The method of claim 19, further comprising:
amplifying the third and fourth signals, converting the third and fourth signals into digital signals, and storing the amplified and digitalized third and fourth signals.
